(19) United States
(12) Patent Application Publication
(10) Pub. No.: US 2024/0400186 A1
(43) Pub. Date: Dec. 5, 2024

(54) AIRCRAFT WINDOW MOISTURE MITIGATION

(71) Applicant: The Boeing Company, Arlington, VA (US)

(72) Inventors: Martin GARIBAY, Montebello, CA (US); Donald B. MACKINTOSH, Seattle, WA (US)

(73) Assignee: The Boeing Company, Arlington, VA (US)

(21) Appl. No.: 18/326,560

(22) Filed: May 31, 2023

(51) Int. Cl. B64C 1/14

(52) U.S. Cl. CPC B64C 1/1484; B64D 2045/0085

(57) ABSTRACT

Systems, apparatuses, and methods provide for a window including a window main body, a moisture sealant rim, and an indicator desiccant. The window main body including an interior portion. The moisture sealant rim is coupled to an outer edge area of the window main body to limit moisture penetration into the interior portion. The indicator desiccant is coupled to the moisture sealant rim and located between the moisture sealant rim and the interior portion of the window main body. The indicator desiccant is to absorb penetrating fluid over time and provide a visual indication of an amount of fluid absorbed.

### TECHNICAL FIELD

The present disclosure generally relates to window moisture mitigation. More particularly, the present disclosure relates to moisture mitigation for electrically heated and unheated pressurized aircraft windshields.

### BACKGROUND

Many laminate-type airplane windshields are subject to moisture ingression that subsequently leads to failure over time. One existing solution utilizes a sealant and metallic z-bar at a moisture path to mitigate moisture ingression.

### SUMMARY

As discussed above, many laminate-type airplane windshields are subject to moisture ingression that subsequently leads to failure over time. One existing solution utilizes a sealant at a moisture path to mitigate moisture ingression. However, such sealant fails over time. Further, ensuring that proper seal is still in in place is typically subjective and dependent on individual judgement when assessing seal bond quality. Accordingly, errors in human judgement can occur when determining when a seal needs to be replaced, which can also result in window failures.

As will be described in greater detail below, in some implementations, a moisture absorbing material can be integrated into a sealant. Advantageously, such a moisture absorbing feature can eliminate subjective inspections and/or subjective maintenance intervals. In some examples, use of such a moisture absorbing material can improve product life.

As will be described in greater detail below, in some implementations discussed herein, systems, apparatuses, and methods provide for a window including a window main body, a moisture sealant rim, and an indicator desiccant. The window main body including an interior portion. The moisture sealant rim is coupled to an outer edge area of the window main body to limit moisture penetration into the interior portion. The indicator desiccant is coupled to the moisture sealant rim and located between the moisture sealant rim and the interior portion of the window main body. The indicator desiccant is to absorb penetrating fluid over time and provide a visual indication of an amount of fluid absorbed.

In one aspect, an apparatus includes a window main body, a moisture sealant rim, and an indicator desiccant. The window main body includes an interior portion. The moisture sealant rim is coupled to an outer edge area of the window main body to limit moisture penetration into the interior portion. An indicator desiccant is coupled to the moisture sealant rim and located between the moisture sealant rim and the interior portion of the window main body. The indicator desiccant is to absorb penetrating fluid over time and provide a visual indication of an amount of fluid absorbed.

In another aspect, a system includes an aircraft fuselage and a windshield. The windshield is coupled to the aircraft fuselage. The windshield includes a window main body, a moisture sealant rim, and an indicator desiccant. The window main body includes an interior portion. The moisture sealant rim is coupled to an outer edge area of the window main body to limit moisture penetration into the interior portion. The indicator desiccant is coupled to the moisture sealant rim and located between the moisture sealant rim and the interior portion of the window main body. The indicator desiccant is to absorb penetrating fluid over time and provide a visual indication of an amount of fluid absorbed.

In yet another aspect, a method, includes applying an indicator desiccant to an outer edge area of a window main body, where the indicator desiccant is to absorb penetrating fluid over time and provide a visual indication of an amount of fluid absorbed; and applying a moisture sealant rim to the outer edge area of the window main body and over at least a portion of the indicator desiccant.

This Summary is provided to introduce a selection of concepts in a simplified form that are further described below in the Detailed Description. The foregoing Summary, as well as the following Detailed Description of certain implementations, will be better understood when read in conjunction with the appended drawings. This Summary is not intended to identify key features or essential features of the claimed subject matter, nor is it intended to be used as an aid in determining the scope of the claimed subject matter.

### BRIEF DESCRIPTION OF THE DRAWINGS

Various examples will be described below by referencing the following drawings, in which:

FIG. 1 is a schematic view illustrating a windshield of an aircraft according to an example;

FIG. 2 is a schematic side view illustrating a window edge of an existing windshield;

FIG. 3 is a schematic side view illustration of a window edge of a windshield according to an example;

FIG. 4 is a cross sectional illustration of another window edge of another windshield according to an example taken along line A-A of FIG. 1;

FIG. 5 is an illustration of a flowchart of an example method for windshield assembly according to an example;

FIG. 6 is an illustration of a flowchart of a further example method for windshield assembly according to an example;

FIG. 7 is a block diagram illustrating a computer program product according to an example;

FIG. 8 is a block diagram illustrating an example fluid delivery apparatus according to an example; and

FIG. 9 is a block diagram illustrating a hardware apparatus including a semiconductor package according to an example.

### DETAILED DESCRIPTION

As described above, many laminate-type airplane windshields are subject to moisture ingression that subsequently leads to failure over time. One existing solution utilizes a sealant at a moisture path to mitigate moisture ingression. Another solution typically utilizes sealant and a metallic z-bar bonded at the periphery with same sealant. For electrically heated windows, these features offer some protection for a transparent electrical heater film in the laminate forming the windshield. For non-heated windshields, these features offer some protection from deterioration for the laminate.

However, such sealant fails over time. Further, the interval at which replacement of such sealant is dependent on wear of the seal, which varies significantly between airplanes. Such variation between airplanes often results in a lack of detection and/or a consistent maintenance planning, which can result in window failures.

Further, ensuring that proper seal is still in in place is typically subjective and dependent on individual judgement when assessing seal bond quality. Accordingly, errors in human judgement can occur when determining when a seal needs to be replaced, which can also result in window failures.

As will be discussed in greater detail below, some systems, apparatuses, and methods described herein address such moisture ingression. Some of the techniques described herein introduces a moisture absorbing feature to improve windshield reliability and/or windshield life. For example, such techniques can mitigate moisture ingression by absorbing excess moisture until the absorption feature is saturated. Additionally, or alternatively, such techniques can allow for predictable maintenance (e.g., by enabling removal and replacement of the seals with the moisture absorbing feature at a discrete and predictable interval).

In some implementations, a moisture absorbing material can be integrated into a sealant. For example, such a moisture absorbing feature can eliminate subjective inspections and/or subjective maintenance intervals. In some examples, an unexposed bead-like and/or a rope-like (e.g., ring-like) feature can be integrated in the sealant for airplane windshield assemblies.

Advantageously, in some examples, use of such a moisture absorbing material can improve product life. Additionally, or alternatively, a displacement of volume of sealant due to the use of such a moisture absorbing material can reduce sealant consumption for a manufacturer.

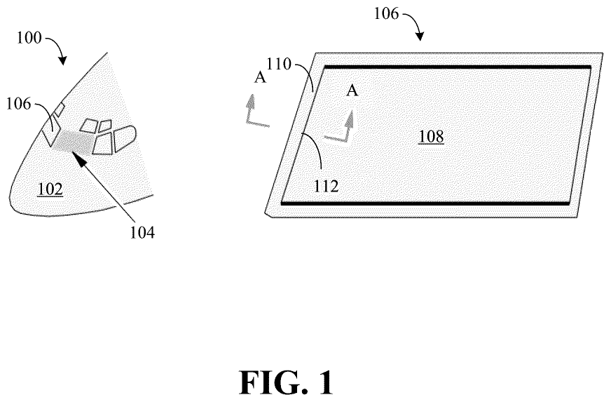

FIG. 1 is a schematic view illustrating a windshield 106 of an aircraft 100 according to an example. In the illustrated example, the aircraft 100 includes an aircraft fuselage 102 (e.g., or other main body) with one or more windshields 106 received within corresponding windshield openings 104.

In some implementations, the windshield 106 is coupled to the aircraft fuselage 102. As will be discussed in greater detail below, the windshield 106 includes a window main body 108 and an indicator desiccant (e.g., illustrated here by numeral 112). Such an indicator desiccant 112 is located within an outer edge area 110 of the window main body 108, for example.

In some implementations, the indicator desiccant 112 is to absorb penetrating fluid over time and provide a visual indication of an amount of fluid absorbed. In some examples, such a visual indication includes a color change. For example, such a color change in the indicator desiccant 112 indicates moisture has breached a moisture sealant. Such a breach can degrade any electrical heating system over time, which can cause electrical arcing, electrical heating system failure, and/or fracture of a non-structural glass ply.

In some examples, the indicator desiccant 112 includes one or more of the following compounds: silicone with cobalt chloride, silica gel with cobalt chloride, silicone with methyl violet, silica gel with methyl violet, the like, and/or combinations thereof.

As will be described in greater detail below, a determination can be made as to whether the indicator desiccant 112 has approached or reached a maximized adsorption capacity. For example, such a determination of whether the indicator desiccant 112 has approached or reached a maximized adsorption capacity can be based on a change in the visual indication of the indicator desiccant 112. In such an example, there can be a threshold amount of change in the visual indication that the determination is based on.

In some implementations, the visual indication of the indicator desiccant 112 includes a color change. For example, in implementations utilizing cobalt chloride based material, such a color change can be from blue to pink. More specifically, blue silica gel having cobalt chloride allows the blue silica gel to change its color to pink when a maximized adsorption capacity is approached or reached. Additionally, or alternatively, in implementations utilizing silica gel having methyl violet based material, such a color change can be from orange to green (e.g., or orange to colorless).

In some implementations, the indicator desiccant 112 includes an expansion percentage of substantially zero percent when saturated. As used herein, the term “substantially zero percent” refers to an expansion percentage of one of the following percent ranges: a zero percent change, a 0.0 percent to 0.01 percent change range, or a 0.0 percent to 0.1 percent range, or the like.

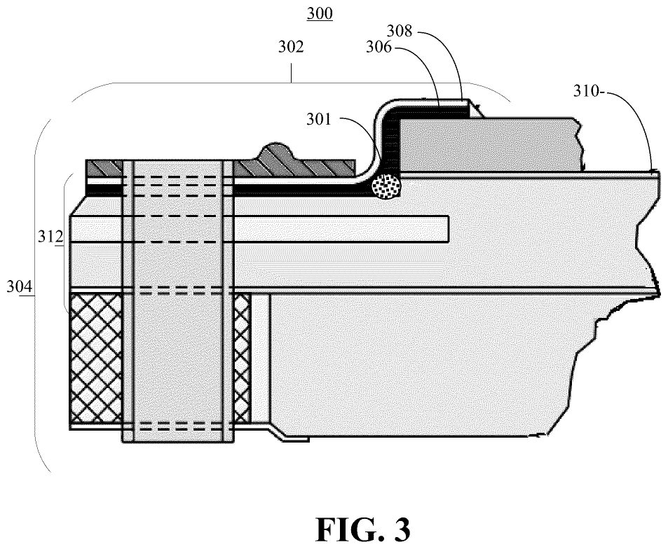

Additional details regarding implementations utilizing the indicator desiccant 112 are found below with respect to FIGS. 3-9.

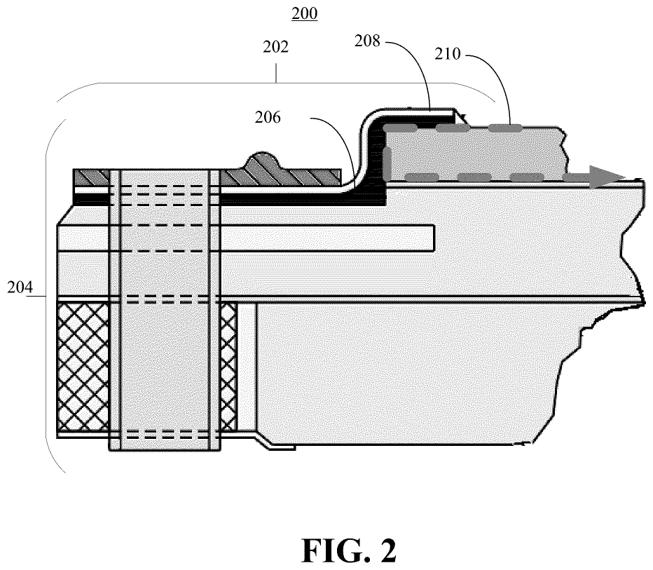

FIG. 2 is a schematic side view illustrating a window edge 202 of an existing windshield 200. In the illustration, the existing windshield 200 includes a seal 206 in the main body 204 and a z-bar 208 covering the seal 206.

As described above, many laminate-type airplane windshields are subject to moisture ingression that subsequently leads to failure over time. As illustrated here, one existing solution utilizes a sealant and a z-bar (e.g., here illustrated as seal 206 and z-bar 208) at a moisture path 210 to mitigate moisture ingression. However, such sealant fails over time, often without a visual indication that failure is currently occurring or will occur in the near future.

FIG. 3 is a schematic side view illustration of an outer edge area 302 of a windshield 300 according to an example. In the illustrated example, an indicator desiccant 301 is located along the outer edge area 302 of the windshield 300.

In some implementations, the windshield 300 includes a window main body 304, a moisture sealant rim 306, a flashing cover 308 (e.g., a z-bar, a z-seal, the like, and/or combinations thereof), and an indicator desiccant 301.

In some examples, such a windshield 300 also includes the heater layer 310. Such a heater layer 310 is located at least partially within an interior portion 312 of the window main body 304, for example.

As used herein the term “heater layer,” as used herein, refers to a window heating electrical system, an anti-ice heating film, the like, and/or combinations thereof.

In some implementations, such a moisture sealant rim 306 is coupled to the outer edge area 302 of the window main body 304. The moisture sealant rim 306 is utilized to limit moisture penetration into the interior portion 312 (e.g., and/or into the heater layer 310).

In some examples, such an indicator desiccant 301 is coupled to the moisture sealant rim 306 and located between the moisture sealant rim 306 and the interior portion 312 of the window main body 304. For example, the indicator desiccant 301 is utilized to absorb penetrating fluid (e.g., absorb fluid that has penetrated moisture sealant rim (306)) over time and provide a visual indication of an amount of fluid absorbed.

In some examples, the windshield 300 includes the flashing cover 308. As illustrated, the flashing cover 308 is located on an outer portion of the moisture sealant rim, for example. Such a flashing cover 308 can be formed of metallic material and/or made of other material (e.g., fiberglass) and can be referred to as a z-bar and/or a z-seal in some implementations.

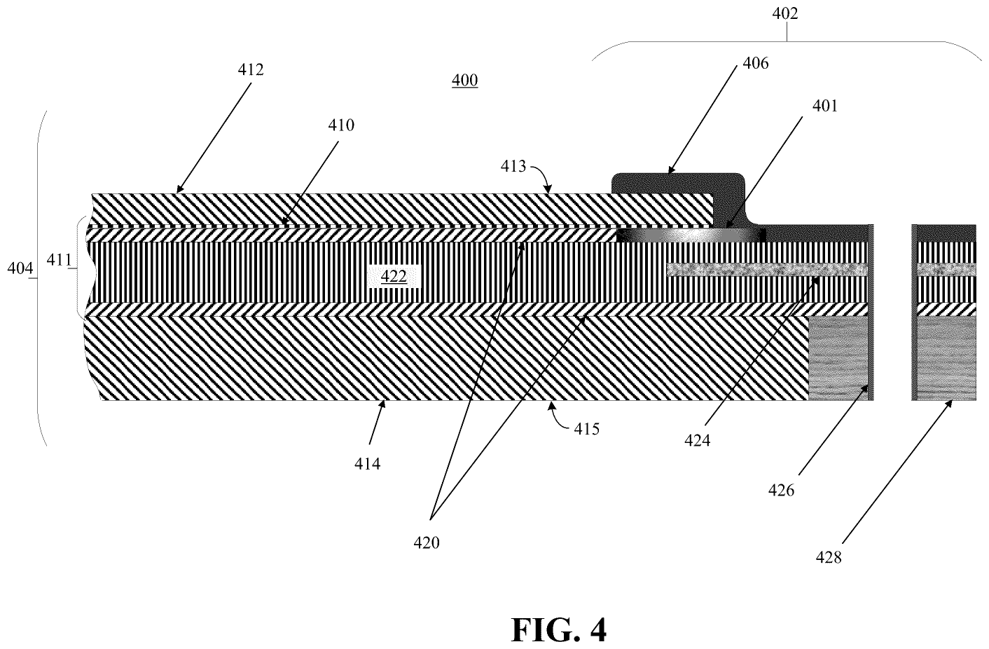

FIG. 4 is a cross sectional illustration of another outer edge area 402 of another windshield 400 according to an example taken along line A-A of FIG. 1. In the illustrated example, FIG. 4 shows one potential location of an indicator desiccant 401.

In the illustrated example, an indicator desiccant 401 is located along the outer edge area 402 of the windshield 400.

In some implementations, the windshield 400 includes a window main body 404, a heater layer 410, a moisture sealant rim 406, and an indicator desiccant 401.

In some examples, such a window main body 404 includes the heater layer 410. Such a heater layer 410 is located at least partially within an interior portion 411 of the window main body 404, for example.

In some implementations, such a moisture sealant rim 406 is coupled to the outer edge area 402 of the window main body 404. The moisture sealant rim 406 is utilized to limit moisture penetration into the heater layer 410.

In some examples, such an indicator desiccant 401 is coupled to the moisture sealant rim 406 and located between the moisture sealant rim 406 and the interior portion 411 of the window main body 404. For example, the indicator desiccant 401 is utilized to absorb penetrating fluid (e.g., absorb fluid that has penetrated moisture sealant rim (406)) over time and provide a visual indication of an amount of fluid absorbed.

In some implementations, the indicator desiccant 401 is located so as to at least partially contact the heater layer 410.

In some examples, the window main body 404 includes an outer window ply 414 located at an outer surface 415 of the window main body 404 and an inner window ply 412 located at an inner surface 413 of the window main body 404. In such an example, the heater layer 410 can be located between the outer window ply 414 and the inner window ply 412.

In some implementations, the indicator desiccant 401 is located at least partially between the heater layer 410 and the inner window ply 412. In such implementations, the indicator desiccant 401 can be located at least partially between outer window ply 414 and the inner window ply 412.

In some examples, the window main body 404 is implemented as a windshield 400 of a pressurized vehicle. In such an example, the indicator desiccant 401 can be located so as to be at least partially outside of a pressure boundary associated with the window main body 404.

As illustrated, such an indicator desiccant 401 can be applied beneath an outer periphery of an outer window ply 414. As will be described in greater detail below, such an indicator desiccant 401 can be directly applied in a lamination process or, to facilitate manufacturing, applied using a prefilled transparent enclosure or mesh.

In the illustrated example, windshield 400 may further optionally include a pair of interlayers 420, a core layer 422, an insert layer 424/426, and an edging 428. In such an example, the core layer 422 may be composed of vinyl, glass, the like, and/or combinations thereof, and may be located between the pair of interlayers 420. The insert layer 424/426 and/or edging 428 may be located along the outer edge area 402 of the windshield 400.

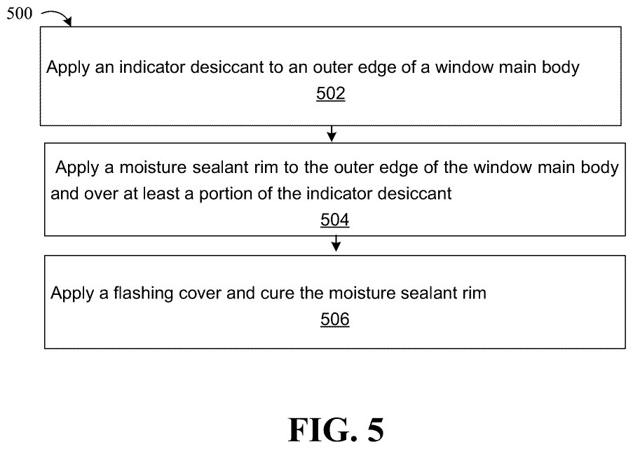

FIG. 5 shows an example method 500 for windshield assembly according to an example. The method 500 can generally be implemented to form an apparatus, such as, for example, the windshield 300 (FIG. 3) and/or the windshield 400 (FIG. 4), already discussed.

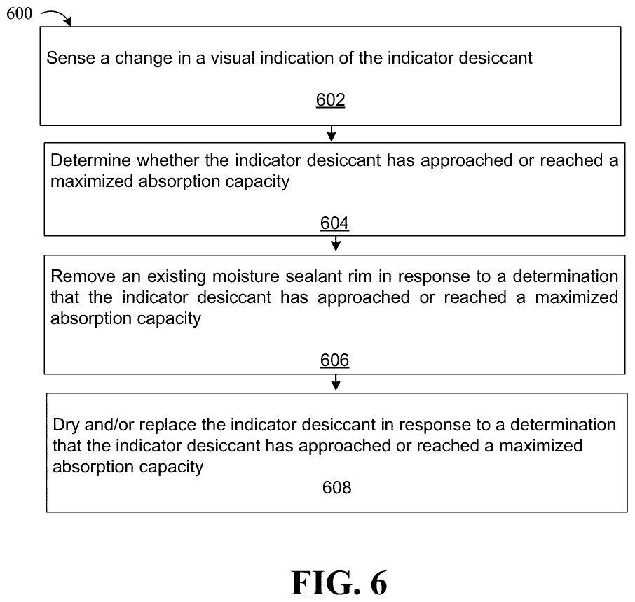

In operation, various steps of method 500 (as well as method 600 (FIG. 6) can be automated. For example, such operations can be implemented via specially designed equipment, robotic systems, the like, and/or combinations thereof.

In an example, the method 500 (as well as method 600 (FIG. 6) can be implemented in computer readable instructions (e.g., software), configurable computer readable instructions (e.g., firmware), fixed-functionality computer readable instructions (e.g., hardware), etc., or any combination thereof.

In some examples, it will be appreciated that some or all of the operations in method 500 (as well as method 600 (FIG. 6) can be performed at least in part by cloud processing.

It will be appreciated that some or all of the operations in method 500 (as well as method 600 (FIG. 6) are described using a “pull” architecture (e.g., polling for new information followed by a corresponding response) can instead be implemented using a “push” architecture (e.g., sending such information when there is new information to report), and vice versa.

Illustrated processing block 502 provides for application of indicator desiccant. For example, such an indicator desiccant can be applied to an outer edge area of a window main body.

In some implementations, the indicator desiccant comprises a rope shaped layer of material.

Additionally, or alternatively, the indicator desiccant comprises a series of beads in some examples. In such an example, Method 500 can include operations to apply a dam barrier to the outer edge area of the window main body in a spaced alignment to accommodate and guide application of the series of beads of the indicator desiccant. Once the series of beads of the indicator desiccant are applied, such a dam barrier can be removed in some examples.

Illustrated processing block 504 provides for application of a moisture sealant rim. For example, such a moisture sealant rim can be applied to the outer edge area of the window main body and over at least a portion of the indicator desiccant.

In some implementations, illustrated processing block 506 provides for applying a flashing cover to the moisture sealant rim and curing the moisture sealant rim. For example, the moisture sealant rim can be cured. As used herein, the term “cured” includes treatment via autoclaving, heat treatment, the like, and/or combinations thereof. Such curing operations may optionally be omitted in implementations where a flashing cover (e.g., a z-bar, a z-seal, the like, and/or combinations thereof) is not utilized.

Additional and/or alternative operations for method 500 are described in greater detail below in the description of FIG. 6.

FIG. 6 is a flowchart of an example of another method 600 for windshield assembly according to an example. The method 600 can generally be implemented to form an apparatus, such as, for example, the windshield 300 (FIG. 3) and/or the windshield 400 (FIG. 4), already discussed.

Illustrated processing block 602 provides for sensing a change in a visual indication of the indicator desiccant. For example, the indicator desiccant can provide such a visual indication with respect to an amount of fluid absorbed.

In operation, block 602 can be implemented via a camera system, a chromatic visual sensor, a colorimeter, a photodetector, a light-emitting diode light sensor, the like, and/or combinations thereof.

Illustrated processing block 604 provides for determining whether the indicator desiccant has approached or reached a maximized adsorption capacity. For example, such a determination of whether the indicator desiccant has approached or reached a maximized adsorption capacity is based on the sensed change in the visual indication of the indicator desiccant. In such an example, there can be a threshold amount of change in the visual indication that the determination is based on.

In some examples, the indicating desiccant can be observed by a scan through the laminated from the outer window ply and/or from the inner window ply.

In some implementations, the visual indication includes a color change. For example, in implementations utilizing cobalt chloride based material, such a color change can be from blue to pink. More specifically, blue silica gel having cobalt chloride allows the blue silica gel to change its color to pink when a maximized adsorption capacity is approached or reached.

Additionally, or alternatively, in implementations utilizing silica gel having methyl violet based material, such a color change can be from orange to green (e.g., or orange to colorless).

Illustrated processing block 606 provides for removal of an existing moisture sealant rim. For example, removal of the existing moisture sealant rim is performed in response to the determination that the indicator desiccant has approached or reached a maximized adsorption capacity.

Illustrated processing block 608 provides for drying and/or replacement of the indicator desiccant. For example, the indicator desiccant can be dried via autoclaving, heat treatment, the like, and/or combinations thereof, in response to the determination that the indicator desiccant has approached or reached a maximized adsorption capacity.

Once the color of the indicator desiccant has changed (e.g., to pink, green, or clear, as a maximized adsorption capacity is approached or reached), the indicator desiccant can be reactivated with heat to dry out the moisture. When the indicator desiccant turns back in color again (e.g., to blue or orange), the indicator desiccant is ready to use again.

In operation, Method 600 can proceed to reapply a new moisture sealant rim and cure the new moisture sealant rim. For example, such operations can be performed in a manner similar to or the same as that described above with respect to Method 500.

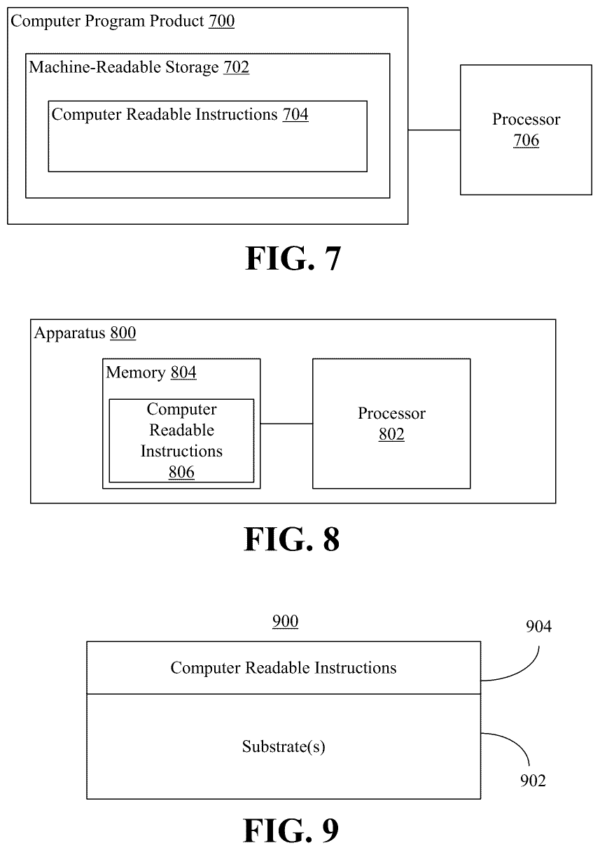

FIG. 7 illustrates a block diagram of an example computer program product 700. In some examples, as shown in FIG. 7, computer program product 700 includes a machine-readable storage 702 that can also include computer readable instructions 704. In some implementations, the machine-readable storage 702 can be implemented as a non-transitory machine-readable storage. In some implementations the computer readable instructions 704, which can be implemented as software, for example. In an example, the computer readable instructions 704, when executed by a processor 706, implement one or more aspects of the method 500 (FIG. 5) and/or the method 600 (FIG. 6), already discussed.

FIG. 8 shows an illustrative example of an apparatus 800. In the illustrated example, the apparatus 800 can include a processor 802 and a memory 804 communicatively coupled to the processor 802. The memory 804 can include computer readable instructions 806, which can be implemented as software, for example. In an example, the computer readable instructions 806, when executed by the processor 802, implement one or more aspects of the method 500 (FIG. 5) and/or the method 600 (FIG. 6), already discussed.

In some implementations, the processor 802 can include a general purpose controller, a special purpose controller, a storage controller, a storage manager, a memory controller, a micro-controller, a general purpose processor, a special purpose processor, a central processor unit (CPU), the like, and/or combinations thereof.

Further, implementations can include distributed processing, component/object distributed processing, parallel processing, the like, and/or combinations thereof. For example, virtual computer system processing can implement one or more of the methods or functionalities as described herein, and the processor 802 described herein can be used to support such virtual processing.

In some examples, the memory 804 is an example of a computer-readable storage medium. For example, memory 804 can be any memory which is accessible to the processor 802, including, but not limited to RAM memory, registers, and register files, the like, and/or combinations thereof. References to “computer memory” or “memory” should be interpreted as possibly being multiple memories. The memory can for instance be multiple memories within the same computer system. The memory can also be multiple memories distributed amongst multiple computer systems or computing devices.

FIG. 9 shows an illustrative semiconductor apparatus 900 (e.g., chip and/or package). The illustrated apparatus 900 includes one or more substrates 902 (e.g., silicon, sapphire, or gallium arsenide) and computer readable instructions 904 (such as, configurable computer readable instructions (e.g., firmware) and/or fixed-functionality computer readable instructions (e.g., hardware)) coupled to the substrate(s) 902. In an example, the computer readable instructions 904 implement one or more aspects of the method 500 (FIG. 5) and/or the method 600 (FIG. 6), already discussed.

In some implementations, computer readable instructions 904 can include transistor array and/or other integrated circuit (IC) components. For example, configurable firmware logic and/or fixed-functionality hardware logic implementations of the computer readable instructions 904 can include configurable computer readable instructions such as, for example, programmable logic arrays (PLAs), field programmable gate arrays (FPGAs), complex programmable logic devices (CPLDs), or fixed-functionality computer readable instructions (e.g., hardware) using circuit technology such as, for example, application specific integrated circuit (ASIC), complementary metal oxide semiconductor (CMOS) or transistor-transistor logic (TTL) technology, the like, and/or combinations thereof.

### Additional Notes and Examples

Clause 1 is an apparatus including a window main body, a moisture sealant rim, and an indicator desiccant. The window main body includes an interior portion. The moisture sealant rim is coupled to an outer edge area of the window main body to limit moisture penetration into the interior portion. An indicator desiccant is coupled to the moisture sealant rim and located between the moisture sealant rim and the interior portion of the window main body. The indicator desiccant is to absorb penetrating fluid over time and provide a visual indication of an amount of fluid absorbed.

Clause 2 includes the apparatus of Clause 1, where the visual indication includes a color change, and where the indicator desiccant includes one or more of the following compounds: silicone with cobalt chloride, silica gel with cobalt chloride, silicone with methyl violet, or silica gel with methyl violet.

Clause 3 includes the apparatus of any one of Clauses 1 to 2, where the indicator desiccant includes an expansion percentage when saturated of substantially zero percent, and where substantially zero percent includes one of the following percent ranges: zero percent, 0.0 percent to 0.01 percent, or 0.0 percent to 0.1 percent.

Clause 4 includes the apparatus of any one of Clauses 1 to 3, further including: a heater layer located at least partially within the interior portion of the window main body; where the indicator desiccant is located so as to at least partially contact the heater layer.

Clause 5 includes the apparatus of Clause 4, where the window main body includes an outer window ply located at an outer surface of the window main body and an inner window ply located at an inner surface of the window main body, where the heater layer is located between the outer window ply and the inner window ply.

Clause 6 includes the apparatus of Clause 5, where the indicator desiccant is located at least partially between the heater layer and the inner window ply.

Clause 7 includes the apparatus of Clause 5, where the indicator desiccant is located at least partially between outer window ply and the inner window ply.

Clause 8 includes the apparatus of any one of Clauses 1 to 7, where the window main body includes a windshield of a pressurized vehicle.

Clause 9 includes the apparatus of Clause 8, where the indicator desiccant is located so as to be at least partially outside of a pressure boundary associated with the window main body.

Clause 10 includes the apparatus of any one of Clauses 1 to 9, where a flashing cover is located on an outer portion of the moisture sealant rim.

Clause 11 includes the apparatus of any one of Clauses 1 to 10, where the indicator desiccant includes a series of beads that have been cured beneath the moisture sealant rim.

Clause 12 includes the apparatus of any one of Clauses 1 to 11, where the indicator desiccant includes a rope shaped layer of material that has been autoclaved beneath the moisture sealant rim.

Clause 13 is a system including an aircraft fuselage and a windshield. The windshield is coupled to the aircraft fuselage. The windshield includes a window main body, a moisture sealant rim, and an indicator desiccant. The window main body includes an interior portion. The moisture sealant rim is coupled to an outer edge area of the window main body to limit moisture penetration into the interior portion. The indicator desiccant is coupled to the moisture sealant rim and located between the moisture sealant rim and the interior portion of the window main body. The indicator desiccant is to absorb penetrating fluid over time and provide a visual indication of an amount of fluid absorbed.

Clause 14 includes system of Clause 13, where the visual indication includes a color change, and where the indicator desiccant includes one or more of the following compounds: silicone with cobalt chloride, silica gel with cobalt chloride, silicone with methyl violet, or silica gel with methyl violet.

Clause 15 includes the system of any one of Clauses 13 to 14, where the indicator desiccant includes an expansion percentage when saturated of substantially zero percent, and where substantially zero percent includes one of the following percent ranges: zero percent, 0.0 percent to 0.01 percent, or 0.0 percent to 0.1 percent.

Clause 16 includes the system of any one of Clauses 13 to 15, further including: a heater layer located at least partially within the interior portion of the window main body; where the indicator desiccant is located so as to at least partially contact the heater layer.

Clause 17 includes the system of Clause 16, where the window main body includes an outer window ply located at an outer surface of the window main body and an inner window ply located at an inner surface of the window main body, where the heater layer is located between the outer window ply and the inner window ply.

Clause 18 is method, including applying an indicator desiccant to an outer edge area of a window main body, where the indicator desiccant is to absorb penetrating fluid over time and provide a visual indication of an amount of fluid absorbed; and applying a moisture sealant rim to the outer edge area of the window main body and over at least a portion of the indicator desiccant.

Clause 19 includes the method of Clause 18, where the visual indication includes a color change, and where the indicator desiccant includes one or more of the following compounds: silicone with cobalt chloride, silica gel with cobalt chloride, silicone with methyl violet, or silica gel with methyl violet.

Clause 19 includes the method of any one of Clauses 18 to 19, where the indicator desiccant includes an expansion percentage when saturated of substantially zero percent, and where substantially zero percent includes one of the following percent ranges: zero percent, 0.0 percent to 0.01 percent, or 0.0 percent to 0.1 percent.

Clause 21 includes a machine-readable storage including machine-readable instructions, which when executed, implement a method or realize an apparatus as claimed in any preceding Clause.

Clause 22 includes an apparatus including means for performing the function of any preceding Clause.

All definitions, as defined and used herein, should be understood to control over dictionary definitions, definitions in documents incorporated by reference, and/or ordinary meanings of the defined terms.

Furthermore, for ease of understanding, certain functional blocks can have been delineated as separate blocks; however, these separately delineated blocks should not necessarily be construed as being in the order in which they are discussed or otherwise presented herein. For example, some blocks can be able to be performed in an alternative ordering, simultaneously, etc.

The terms “coupled,” “attached,” or “connected” can be used herein to refer to any type of relationship, direct or indirect, between the components in question, and can apply to electrical, mechanical, fluid, optical, electromagnetic, electro-mechanical or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action can occur, either in a direct or indirect manner.

Although a number of illustrative examples are described herein, it should be understood that numerous other modifications and examples can be devised by those skilled in the art that will fall within the spirit and scope of the principles of the foregoing disclosure. More particularly, reasonable variations and modifications are possible in the component parts and/or arrangements of the subject combination arrangement within the scope of the foregoing disclosure, the drawings and the appended claims without departing from the spirit of the foregoing disclosure. In addition to variations and modifications in the component parts and/or arrangements, alternative uses will also be apparent to those skilled in the art. The examples can be combined to form additional examples.

We claim:

1. An apparatus comprising:
a window main body including an interior portion;
a moisture sealant rim coupled to an outer edge area of the window main body to limit moisture penetration into the interior portion; and
an indicator desiccant coupled to the moisture sealant rim and located between the moisture sealant rim and the interior portion of the window main body, and wherein the indicator desiccant is to absorb penetrating fluid over time and provide a visual indication of an amount of fluid absorbed.

2. The apparatus of claim 1, wherein the visual indication comprises a color change, and wherein the indicator desiccant comprises one or more of the following compounds: silicone with cobalt chloride, silica gel with cobalt chloride, silicone with methyl violet, or silica gel with methyl violet.

3. The apparatus of claim 1, wherein the indicator desiccant comprises an expansion percentage when saturated of substantially zero percent, and wherein substantially zero percent comprises one of the following percent ranges: zero percent, 0.0 percent to 0.01 percent, or 0.0 percent to 0.1 percent.

4. The apparatus of claim 1, further comprising:
a heater layer located at least partially within the interior portion of the window main body; and
wherein the indicator desiccant is located so as to at least partially contact the heater layer.

5. The apparatus of claim 4, wherein the window main body comprises an outer window ply located at an outer surface of the window main body and an inner window ply located at an inner surface of the window main body, wherein the heater layer is located between the outer window ply and the inner window ply.

6. The apparatus of claim 5, wherein the indicator desiccant is located at least partially between the heater layer and the inner window ply.

7. The apparatus of claim 5, wherein the indicator desiccant is located at least partially between outer window ply and the inner window ply.

8. The apparatus of claim 1, wherein the window main body comprises a windshield of a pressurized vehicle.

9. The apparatus of claim 8, wherein the indicator desiccant is located so as to be at least partially outside of a pressure boundary associated with the window main body.

10. The apparatus of claim 1, wherein a flashing cover is located on an outer portion of the moisture sealant rim.

11. The apparatus of claim 1, wherein the indicator desiccant comprises a series of beads that have been cured beneath the moisture sealant rim.

12. The apparatus of claim 1, wherein the indicator desiccant comprises a rope shaped layer of material that has been autoclaved beneath the moisture sealant rim.

13. A system comprising:
an aircraft fuselage; and
a windshield coupled to the aircraft fuselage, the windshield comprising:
a window main body with an interior portion;
a moisture sealant rim coupled to an outer edge area of the window main body to limit moisture penetration into the interior portion; and
an indicator desiccant coupled to the moisture sealant rim and located between the moisture sealant rim and the interior portion of the window main body, and wherein the indicator desiccant is to absorb penetrating fluid over time and provide a visual indication of an amount of fluid absorbed.

14. The system of claim 13, wherein the visual indication comprises a color change, and wherein the indicator desiccant comprises one or more of the following compounds: silicone with cobalt chloride, silica gel with cobalt chloride, silicone with methyl violet, or silica gel with methyl violet.

15. The system of claim 13, wherein the indicator desiccant comprises an expansion percentage when saturated of substantially zero percent, and wherein substantially zero percent comprises one of the following percent ranges: zero percent, 0.0 percent to 0.01 percent, or 0.0 percent to 0.1 percent.

16. The system of claim 13, further comprising:
a heater layer located at least partially within the interior portion of the window main body; and
wherein the indicator desiccant is located so as to at least partially contact the heater layer.

17. The system of claim 16, wherein the window main body comprises an outer window ply located at an outer surface of the window main body and an inner window ply located at an inner surface of the window main body, wherein the heater layer is located between the outer window ply and the inner window ply.

18. A method, comprising:
applying an indicator desiccant to an outer edge area of a window main body, wherein the indicator desiccant is to absorb penetrating fluid over time and provide a visual indication of an amount of fluid absorbed; and
applying a moisture sealant rim to the outer edge area of the window main body and over at least a portion of the indicator desiccant.

19. The method of claim 18, wherein the visual indication comprises a color change, and wherein the indicator desiccant comprises one or more of the following compounds: silicone with cobalt chloride, silica gel with cobalt chloride, silicone with methyl violet, or silica gel with methyl violet.

20. The method of claim 18, wherein the indicator desiccant comprises an expansion percentage when saturated of substantially zero percent, and wherein substantially zero percent comprises one of the following percent ranges: zero percent, 0.0 percent to 0.01 percent, or 0.0 percent to 0.1 percent.
